(19) United States
(12) Patent Application Publication
(10) Pub. No.: US 2026/0252401 A1
(43) Pub. Date: Aug. 27, 2026

(54) ARTIFICIAL INTELLIGENCE HUB FOR INFERENCE OPERATIONS ON LOCAL NETWORKS

(71) Applicant: NVIDIA Corporation, Santa Clara, CA (US)

(72) Inventor: Preston Goode, Cleveland, TN (US)

(73) Assignee: NVIDIA Corporation, Santa Clara, CA (US)

(21) Appl. No.: 19/064,997

(22) Filed: Feb. 27, 2025

(51) Int. Cl. G06F 9/50; H04L 45/24; H04L 67/10

(52) U.S. Cl. CPC G06F 9/5044; G06F 9/5038; H04L 45/24; H04L 67/10

(57) ABSTRACT

In various examples, systems and methods are disclosed relating to inference operations on local networks. A system can receive, from a device of a local network, a request for an inference task. The system can select a first inference device of a plurality of inference devices connected to the local network based at least on the inference task and one or more processing capabilities of the plurality of inference devices. The system can provide an indication of the first inference device to the device of the local network in response to the request.

### BACKGROUND

Machine-learning inference tasks are typically executed on computing devices that include specialized hardware, to improve computational efficiency. It can be challenging to efficiently execute machine-learning inference tasks in local network environments.

### SUMMARY

The present disclosure is directed to techniques for implementing an artificial intelligence hub within a local network environment. Traditional approaches to performing artificial intelligence inference operations involve sending data to remote servers or cloud-based platforms for processing, which introduces significant latency due to network transmission delays and bandwidth limitations. Furthermore, such approaches may violate privacy constraints for data that is to be processed, as sensitive information may be transmitted over potentially insecure networks or processed by systems that lack sufficient cybersecurity frameworks. Although some solutions implement local processing operations, conventional approaches for implementing artificial intelligence models in a local network environment fail to fully utilize local computational resources. For instance, personal computers equipped with graphics processing units (GPUs) often remain idle or operate at low capacity. Similarly, internet of things (IoT) devices may possess specialized hardware capable of performing advanced computations but are not leveraged effectively.

The techniques described herein provide an artificial intelligence hub that can operate within a local network environment and can dynamically allocate computational resources for inference operations based on real-time availability and processing suitability. These approaches can be implemented to minimize latency by processing data as close to its source as possible (e.g., within the local network), thereby reducing reliance on remote servers or cloud platforms while maintaining high performance through the dynamic allocation of inference tasks. The artificial intelligence hub can access deployed deep learning models hosted across various devices within the local network as microservices. In some implementations, inference tasks can be scheduled based at least on optimal compute locations by considering factors such as power mode and network availability. The dynamic allocation of artificial intelligence tasks improves upon overall system performance by leveraging underutilized resources relative to conventional approaches for locally executing artificial intelligence models.

At least one aspect relates to one or more processors. The one or more processors can include one or more circuits. The one or more circuits can receive, from a device of a local network, a request for an inference task. The one or more circuits can select a first inference device of a plurality of inference devices connected to the local network based at least on the inference task and/or one or more processing capabilities of the plurality of inference devices. The one or more circuits can provide an indication of the first inference device to the device of the local network in response to the request.

In some implementations, the one or more circuits can store a list of identifiers of the plurality of inference devices in association with the one or more processing capabilities. In some implementations, the one or more circuits can select the first inference device according to an order of the list of identifiers. In some implementations, the one or more circuits can update the list of identifiers of the plurality of inference devices based at least on one or more responses to a multicast message transmitted via the local network. In some implementations, the one or more circuits can provide a network address of the first inference device as part of the indication.

In some implementations, the one or more circuits can receive, from the first inference device, data indicative of at least one machine-learning model stored at the first inference device. In some implementations, the one or more circuits can update the one or more processing capabilities of the plurality of inference devices based at least on the data indicative of the at least one machine-learning model. In some implementations, the one or more circuits can determine that the first inference device comprises sufficient computational resources for the inference task. In some implementations, the one or more circuits can select the first inference device responsive to determining that the first inference device comprises sufficient computational resources for the inference task.

In some implementations, the one or more circuits can transmit to a second inference device of the plurality of inference devices, a message corresponding to the inference task. In some implementations, the one or more circuits can determine that the second inference device failed to provide a response to the message within a time limit. In some implementations, the one or more circuits can select the first inference device responsive to determining that the second inference device failed to provide the response within the time limit. In some implementations, the one or more circuits can receive data for the inference task from the device of the local network. In some implementations, the one or more circuits can provide the data for the inference task to the first inference device responsive to selecting the first inference device. In some implementations, the one or more circuits can receive, from the first inference device, output information generated by the first inference device according to the inference task. In some implementations, the one or more circuits can generate a schedule for a plurality of inference tasks received from a plurality of devices via the local network.

At least one aspect relates to a system. The system can include a plurality of inference devices in communication via a local network. Each of the plurality of inference devices can store a respective machine-learning model. The system can include a controller device in communication with the local network. The controller device can generate, via communications with the local network, a list of the plurality of inference devices in communication with the local network. The controller device can receive an indication of an inference task from a client device. The controller device can select an inference device of the plurality of inference devices based at least on the inference task and the respective machine-learning model stored at each of the plurality of inference devices. The controller device can generate a response to the request based at least on the selected inference device.

In some implementations, the controller device can provide a local network address of the selected inference device in response to the request. In some implementations, the controller device can communicate data for the inference task to the selected inference device. In some implementations, the controller device can monitor execution of the inference task at the selected inference device. In some implementations, the controller device can provide, to the client device, an output of the inference task generated by the selected inference device. In some implementations, the controller device can be included in the plurality of inference devices. In some implementations, the selected inference device can be a first inference device, and the controller device can determine, based at least on second network communications, that a second inference device of the plurality of inference devices is unavailable to perform the inference task. In some implementations, the controller device can select the first inference device based at least on the second inference device being unavailable.

At least one aspect is related to a method. The method can include receiving, from a device of a local network, a request for an inference operation. The method can include selecting a first inference device of a plurality of inference devices connected to the local network based on at least one of the inference operation or one or more processing capabilities of the plurality of inference devices. The method can include allocating at least a portion of the inference operation to the first inference device.

In some implementations, the method can include storing a list of identifiers of the plurality of inference devices in association with the one or more processing capabilities. In some implementations, the method can include selecting the first inference device according to an order of the list of identifiers. In some implementations, the method can include updating the list of identifiers of the plurality of inference devices based at least on one or more responses to a multicast message transmitted via the local network. In some implementations, the method can include providing an indication of the first inference device to the device of the local network in response to the request, the indication including a network address of the first inference device as part of the indication.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a small language model, a system for performing generative AI operations using a vision language model, a system for performing generative AI operations using a multimodal language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing an artificial intelligence hub for inference operations on local networks are described in detail below with reference to the attached drawing figures, wherein:

FIG. 1 is a block diagram of an example system for implementing inference operations on local networks, in accordance with some embodiments of the present disclosure;

FIG. 2 depicts an example diagram showing an example process implemented by one or more computing systems described herein to perform inference operations on local networks, in accordance with some embodiments of the present disclosure;

FIG. 3 is a flow diagram of an example of a method for implementing inference operations on local networks, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for implementing an artificial intelligence hub within a local network environment. Traditional approaches to performing artificial intelligence inference operations involve sending raw sensor or device-generated data to remote servers or cloud-based platforms for processing, which introduces significant latency due to network transmission delays and bandwidth limitations. Furthermore, such approaches may violate privacy constraints for data that is to be processed, as sensitive information may be transmitted over potentially insecure networks or processed by systems that lack sufficient cybersecurity frameworks.

Although some solutions implement local processing operations, conventional approaches for implementing artificial intelligence models in a local network environment fail to fully utilize local computational resources. For instance, personal computers equipped with graphics processing units (GPUs) often remain idle or operate at low capacity during periods when users do not require intensive computing tasks. Similarly, internet of things (IoT) devices may possess specialized hardware capable of performing advanced computations but lack the necessary software frameworks to leverage these capabilities effectively.

The techniques described herein provide an artificial intelligence hub that can operate within a local network environment and can dynamically allocate computational resources for inference operations based on real-time availability and processing suitability. These approaches can be implemented to minimize latency by processing data as close to its source as possible (e.g., within the local network), thereby reducing reliance on remote servers or cloud platforms while maintaining high performance through the dynamic allocation of inference tasks. The artificial intelligence hub can access deployed deep learning models hosted across various devices within the local network as microservices.

The inference tasks can be scheduled using these techniques based at least on optimal compute locations by considering factors such as power mode and network availability. For example, if a personal computer with an idle GPU is present in the network, the artificial intelligence hub can direct certain computational-intensive tasks to this device rather than relying solely on less powerful devices or high-latency cloud services. The dynamic allocation of artificial intelligence tasks improves upon overall system performance by leveraging underutilized resources relative to conventional approaches for locally executing artificial intelligence models.

Moreover, the implementation of a decentralized and flexible resource management strategy allows the artificial intelligence hub to operate seamlessly across different platforms while maintaining consistent user experiences. The use of multicast DNS facilitates easy discovery and accessibility of the AI hub within local networks without requiring complex configuration steps or specialized knowledge from end-users. This approach represents a significant advancement over previous solutions that either relied exclusively on centralized cloud services or failed to dynamically allocate resources based on real-time conditions.

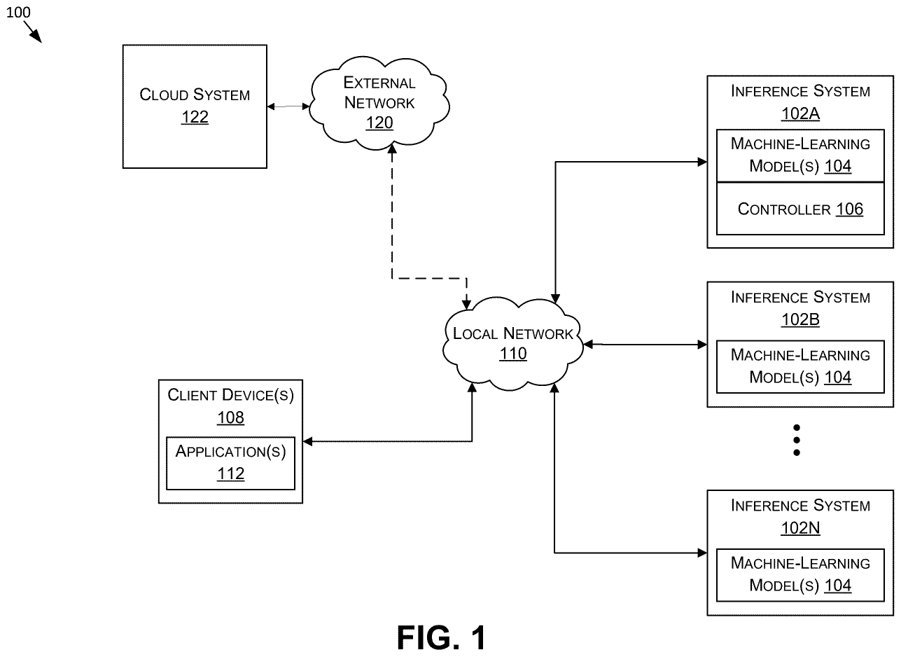

With reference to FIG. 1, FIG. 1 is an example computing environment including a system for implementing an artificial intelligence hub for inference operations on local networks, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can be utilized to execute machine-learning (e.g., artificial intelligence) inference operations on local networks. The system 100 is shown as including one or more inference systems 102A-102N (sometimes generally referred to as the “inference system(s) 102” or the “inference device(s) 102”), at least one client deice 110, and at least one local network 110. In some implementations, the local network 110 may be in communication with one or more cloud systems 122 via at least one external network 120. Each of the inference systems 102 can include at least one machine-learning model 104. At least one of the inference systems 102 (shown here as the inference system 102A) can include a controller 106. One or more client devices 108 can store and/or execute one or more applications 112 to request execution of inference tasks via the local network 110.

The local network 110 can be any type of network infrastructure that facilitates communication among computing devices. In some implementations, the local network 110 may be confined to a set of computing devices within a geographic area, and may include home networks, office/enterprise networks, or campus networks, among others. Examples of the local network 110 include, but are not limited to, Wi-Fi networks, Ethernet-based local area networks (LANs), and Bluetooth personal area networks (PANs), or combinations thereof, among others. In some implementations, the local network 110 may include virtual private networks (VPNs). The local network 110 can support various communication protocols and standards, enabling seamless interaction between different types of devices and systems.

The local network 110 can coordinate communications between any computing devices coupled thereto, including between one or more client devices 108 and one or more inference systems 102. To do so, the local network 110 can facilitate data transmission, routing of packets, enforcing firewalls or other security measures, while ensuring that devices can discover and communicate with one another efficiently. The local network 110 may include any number of switches, routers, or other devices that facilitate the transmission or routing of network data (e.g., network packets). In some implementations, the local network 110 or devices thereof may employ network management protocols and services, such as Dynamic Host Configuration Protocol (DHCP) for automatic IP address assignment, Domain Name System (DNS) for name resolution, and multicast DNS (mDNS) for service discovery, among others.

In some implementations, the local network 110 may be in communication with one or more external networks 120, such as wide area networks (WANs), the internet, or other private or public networks. Devices within the local network 110, such as routers or gateways, can coordinate access to the external network 120. For example, a router can manage the routing of network traffic between the local network 110 and the external network 120, ensuring that data packets are correctly forwarded to their intended destinations. The router can also handle network address translation (NAT) to enable devices within the local network 110 to communicate with devices on the external network 120 using private internet protocol (IP) addresses.

The external network 120 can enable access to one or more cloud systems 122 and/or external computing systems (e.g., computing systems external to the local network 110). The external network 120 can facilitate the transmission of data between the local network 110 and cloud systems 122. Devices within the local network 110 can communicate with external computing systems via the external network 120 to retrieve data and/or access functionality of the cloud system 122. For example, cloud systems 122 can provide storage, computing resources, and machine-learning models that can be accessed by devices within the local network 110. In some implementations, routers/switches of the local network 110 may prevent devices of the external network 120 (which may include the cloud system) from accessing to certain ports or other network resources of the local network 110 or the devices thereof (e.g., via configuration settings, firewalls, network routing rules, etc.).

The cloud system 122 can be any type of cloud computing system or distributed computing environment. In some implementations, the cloud system 122 can be a collection of remote servers and infrastructure that provide various cloud services. The cloud system 122 can include data centers, servers, storage devices, and networking equipment, among other computing devices. In some implementations, the cloud system 122 can be provide one or more cloud services, including remote computing, storage, and application hosting. The cloud system 122 can be accessed via the external network 120. In some implementations, the cloud system 122 may provide or otherwise store one or more machine-learning models 104 or other types of services for one or more inference systems 102. For example, the cloud system 122 can host machine-learning models 104 in various formats, such as software packages, containers, or microservices, making them available for retrieval and execution by the inference systems 102, as described in further detail herein.

The client device 108 can be any type of computing device capable of executing applications and communicating over a network. Examples of the client device 108 include, but are not limited to, smartphones, tablets, personal computers, laptops, and smart home devices. The client device 108 can include various hardware components such as a processor, memory, storage, input/output interfaces, and network interfaces. The client device 108 can communicate via the local network 110 using various communication protocols, including Wi-Fi, Ethernet, or Bluetooth, among others. The client device 108 can execute one or more applications 112, which can be stored and executed by the device or accessed via a web browser. In implementations where the application 112 is accessed via a web-browser, a web-based application may be provided by a controller 106 of an inference system 102A, as described in further detail herein.

The application 112 can be any type of software, hardware, or combination of hardware and software that provides a user interface and/or application programming interface (API) to perform the various operations described herein. In some implementations, the application 112 can provide a graphical user interface that enables a user to specify, configure, and/or request execution of inference tasks by devices (e.g., inference systems 102) of the local network 110. The application 112 can receive input from the user, which may include data, selections thereof, and configurations thereof for inference tasks. In some implementations, the application 112 can receive configurations/data for inference tasks via one or more API calls, inter-process communications, or other types of input.

Inference tasks may include any type of processing task that involves machine-learning models or artificial intelligence operations. Examples of such tasks include, but are not limited to, image recognition, object detection, natural language processing, speech recognition, and predictive analytics. Image recognition tasks can involve identifying and classifying objects within images or videos. Object detection tasks can extend beyond simple recognition to locate and delineate objects within an image or video frame. Natural language processing tasks can encompass sentiment analysis, language translation, text summarization, or other generative text operations involving one or more language models (e.g., large language models (LLMs), small language models (SLMs), etc.). Speech recognition tasks can involve transcribing spoken words into text, while predictive analytics tasks can forecast future trends based on historical data.

As described herein, the application 112 can receive selections and configurations for different types of inference tasks through a user interface or via API calls from other applications executing on the client device 108. For example, the application 112 can present a menu or a series of options that allow the user to select the specific type(s) of inference task(s) to be performed. In some implementations, other applications executing on the client device 108 can request inference tasks by making API calls or otherwise communicating with the application 112. The other applications/processes of the client device 108 may provide or otherwise specify parameters for the inference task, identify input data for the inference task, and/or provide any additional configuration settings for the inference task. In some implementations, the application 112 can also facilitate inter-process communication to receive inference task requests from other applications running on the client device 108.

In an implementation where the application 112 enables configuration of an inference task via a user interface, the application 112 can provide one or more configuration options for one or more selectable interference tasks. Example configuration operations include but are not limited to identifying/specifying the input data for the inference task, setting task-specific parameters for the inference task, or defining/specifying output formats for the inference task, among others. Once the user or another application has configured the task, the application 112 can transmit a request to perform the inference task to a controller 106 of an inference system 102 of the local network 110. The request can include one or more of the specified parameters of the inference task. In some implementations, the application 112 can transmit the input data for the inference task to the controller 106, as part of or in addition to the request.

The network address of the inference system 102 executing the controller 106 may be stored in an internal configuration of the application 112 or determined dynamically from multicast or other communication via the local network 110. In some implementations, a user and/or application may specify/select the controller 106 and/or the inference system 102 via a corresponding interface of the application 112. In some implementations, the application 112 can use multicast DNS or other service discovery protocols to identify inference systems 102 having a controller 106. Once the network address of the inference system 102A is known, the application 112 can establish a communication channel with the corresponding controller 106 to transmit inference tasks and receive results, as described in further detail herein. The application 112 can handle various aspects of communication, including but not limited to error checking, retransmission, and status updates, among others.

In some implementations, the client device 108 may be an IoT device that includes one or more sensors, such as cameras, temperature sensors, humidity sensors, or motion detectors, among other types of sensors. Various processes, firmware, or other control instructions can cause the sensors of the client device 108 to capture various sensor data (e.g., images, temperature readings, etc.). In such implementations, the application 112 on the client device 108 may be an embedded application, firmware, or any other type of software component (or combination of hardware and software) that can execute on an IoT device. In some implementations, the application 112 can access data from the sensors (or from other processes controlling/operating the sensors) and transmit requests to the controller 106 to process the sensor data using one or more machine-learning models 104, as described herein. For example, the application 112 can send image data captured by a camera to the controller 106 for object detection or send temperature and humidity data to the controller 106 for environmental analysis/prediction. The client device 108 can communicate with the controller 106 of one or more inference systems 102 via the local network 110 to facilitate the transmission of sensor data and the execution of inference tasks, as described in further detail herein.

The inference systems 102 can be any type of computing device capable of executing machine-learning operations or portions thereof. Such devices can include, but are not limited to, personal computers, laptops, smartphones, tablets. In some implementations, one or more of the inference systems 102 may include specialized hardware such as graphics processing units (GPUs), tensor processing units (TPUs), and field-programmable gate arrays (FPGAs), among others. In some implementations, the inference systems 102 may store libraries, drivers, or other types of software or combinations of hardware and software that are optimized for performing specific types of computations, such as matrix multiplications, tensor operations, convolution operations, or other types of mathematical operations common for machine-learning tasks.

Each of the inference system 102 may have different processing capabilities. For example, a personal computer including a high-performance GPU may process complex and computationally intensive tasks, whereas a laptop, smartphone, or IoT device may be limited to simpler operations due to constraints in processing power and memory. The inference systems 102 can communicate with one another and other computing devices, such as the client device 108 and/or the external network 120, via the local network 110. For example, one or more of the inference systems 102 can use the local network 110 exchange data, coordinate inference task assignments, or perform any of the operations described herein. Each inference system 102 can communicate via the local network 110 using any suitable communications protocol, including but not limited to Wi-Fi, Ethernet, or Bluetooth, among others.

Each inference system 102 can store one or more machine-learning models 104 that are used to execute one or more inference tasks or portions thereof. Examples of machine-learning models 104 include convolutional neural networks (CNNs) for image recognition and object detection, transformer-based models such as generative pre-trained transformer (GPT) models or other language models such as recurrent neural networks (RNNs) for natural language processing and speech recognition, diffusion-based models for image and/or video generation, and other types of machine-learning models (e.g., regression models, sparse vector machine models, decision tree models, etc.) for generating predictions based on input data, among others. In some implementations, one or more of the inference systems 102 may store or maintained multiple machine-learning models, each of which may correspond to a different inference task, input data type, or output prediction/output data.

The machine-learning models 104 may be stored as software packages, containers, or other types of software services, such as microservices. For example, the machine-learning models 104 can be provided within containers components, which can include runtime libraries and configuration settings for executing one or more machine-learning models 104. In some implementations, the machine-learning models 104 may be retrieved, downloaded, or otherwise accessed from one or more cloud systems 122 or external computing devices via the external network 120. The inference system 102 can communicate with the cloud systems 122 or external computing devices to download/retrieve the corresponding machine-learning models 104 and/or other software components/services. In some implementations, the machine-learning models 104 can be stored in cloud storage services, container registries, or other repositories accessible via the external network 120.

In some implementations, one or more of the inference systems 102 may store and/or execute other software components and/or services in addition to one or more machine-learning models 104, such as data pre-processing services. Data pre-processing services can include instructions to automatically format/convert raw sensor data into a format suitable for one or more machine-learning models 104. In some implementations, data pre-processing may be performed by one or more of the inference systems 102 described herein to pre-process input data for an inference task prior to executing one or more machine-learning models 104. In some implementations, and as described in further detail herein, multiple tasks (e.g., pre-processing, machine-learning inference, etc.) may be scheduled for execution by one or more inference systems 102 of the local network 110 to carry out one or more inference tasks requested by one or more client devices 108.

At least one of the inference systems 102 can execute a controller 106. The controller 106 can include software, hardware, or combinations of hardware and software. The controller 106 can store/maintain a list/data structure including each of the inference systems 102 of the local network 110. The controller 106 can schedule, coordinate, and in some implementations process one or more inference tasks transmitted from one or more client devices 108 using the inference systems 102 of the local network 110. For example, the controller 106 can receive inference tasks (e.g., via a suitable API call, etc.) from a client device 108, select one or more of the inference systems 102 to carry out the inference task, and coordinate execution of the inference task via the local network 110.

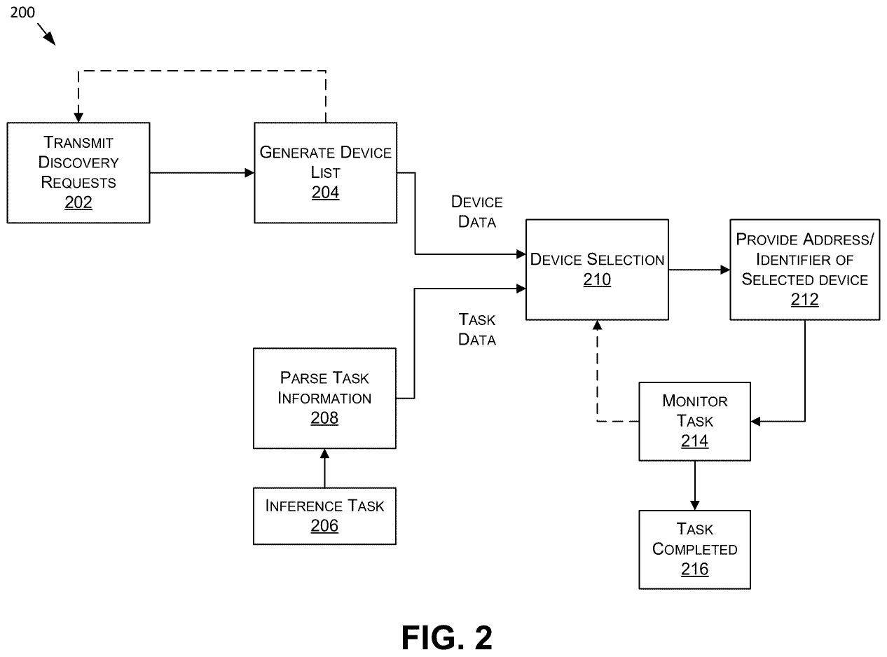

In some implementations, once the controller 106 has selected one or more inference systems 102 to process the inference task, the controller 106 can transmit a network address (e.g., an API endpoint address, a uniform resource locator (URL), a uniform resource identifier (URI), etc.) of the selected inference system(s) 102 to the requesting client device 108. In such implementations, the application 112 can access and transmit input data and parameters for the inference task to the selected inference system(s) 102 using the provided network address. In some implementations, the controller 106 can coordinate execution of the inference task by receiving the input data and parameters from the application. In such implementations, the controller 106 can automatically transmit the input data and parameter(s) for the inference task to the selected inference system(s) 102 via the network address(es). Further details of the processes implemented by the controller 106 are described in connection with FIG. 2.

Referring to FIG. 2 in the context of the components described in connection with FIG. 1, depicted is an example diagram showing an example process 200 implemented by controller 106 to perform/coordinate execution of inference task on a local network, in accordance with some embodiments of the present disclosure. As described herein, each inference system 102 can be a computing system capable of performing one or more machine-learning operations or data processing operations (e.g., using machine-learning model(s) 104, using other software components, etc.). At step 202 of the process 200, the controller 106 can identify one or more inference systems 102 in communication with the local network 110 by transmitting discovery requests via the local network 110. The discovery requests may include requests for processing capabilities and/or other properties of the inference systems 102 (e.g., indications of hardware data, stored/maintained machine-learning models 104, etc.).

In some implementations, the controller can transmit one or more mDNS requests to discover and communicate with different inference systems 102 connected to the local network 110. Each inference system 102 can respond to mDNS queries transmitted by the controller 106 by transmitting response messages that include corresponding status data (e.g., available, unavailable, etc.) and processing capabilities. In some implementations, the multicast messages may be transmitted on one or more ports of the local network 110 specific to the inference systems 102 (e.g., corresponding to an API endpoint maintained by the inference systems 102, etc.).

In some implementations, one or more inference systems 102 may provide an API endpoint via which the controller 106 and/or the client devices 108 can access the inference systems 102. In one example, the API endpoints can expose various functionalities, such as retrieving information about the inference system 102, providing input data for inference tasks, coordinating execution of inference tasks, retrieving output data generated by inference tasks, and monitoring execution of inference tasks, among other functionality. In some implementations, the controller 106 can use these API endpoints to interact with the inference systems 102 and retrieve processing capabilities for each identified inference system 102.

At step 204, the controller 106 can generate a list of inference systems 102, which can include the processing capabilities, status, and network address of each inference system 102 identified via the multicast communications transmitted on the local network 110. To do so, the controller 106 can communicate with the inference systems 102 (e.g., via their corresponding API endpoints/network addresses) to retrieve information relating to the processing capabilities of the inference systems 102. Examples of different processing capabilities include, but are not limited to, hardware specifications (e.g., GPU model, CPU architecture), memory capacity, available storage, and network bandwidth, among others. The processing capabilities may include information relating to which machine-learning models 104 and/or software components are stored at the inference system 102. In some implementations, the controller 106 may communicate with the inference systems 102 to coordinate retrieval of one or more suitable machine-learning models 104 from the cloud system 122 or another external computing system. For example, the controller 106 may automatically cause an inference system 102 that can perform an inference task to automatically download/retrieve a machine-learning model 104 suitable for the inference task from the cloud system 122 or another external computing system.

In some implementations, the controller 106 can periodically update the list of devices by performing step 202 of the process 200 to identify any changes in the number or processing capabilities of the inference systems 102 connected to the local network 110. For example, the controller can automatically and dynamically update the list of inference systems 102 as new inference systems 102 connect to the local network 110 or disconnect from the local network 110. In some implementations, the controller 106 can periodically transmit multicast requests via the local network 110 to detect changes in processing capabilities, stored/maintained machine-learning models 104, or state changes to one or more of the inference systems 102 connected to the local network 110.

At step 206, the controller 106 can receive one or more inference tasks from one or more client devices 108. As described herein, the inference tasks may include indications of parameters for the inference task, such as the type of machine-learning model 104 to be used, input data, and any additional configuration settings. Examples of types of information that may be specified as part of the inference task include, but are not limited to, the format and content of the input data (e.g., image, text, audio), thresholds or constraints for the inference process (e.g., confidence levels, processing time limits), and format/type of output data to be generated via the inference task. In some implementations, the inference tasks can specify parameters/instructions to pre-process input data (e.g., an indication to convert input data to a specified format, etc.).

At step 208, the controller 106 can parse the received inference tasks to generate task data. For example, the controller 106 can parse an API call provided by the application 112 of a client device to generate a data structure including processing requirements and/or parameters for the inference task, which can be used in subsequent steps to select one or more inference systems 102 to execute the inference task. In some implementations, parsing a received inference task request can include validating the request and any parameters provided therein. For example, the controller 106 can determine whether the inference task includes valid parameter values and that the inference task request does not include corrupted or incomplete data. In some implementations, if the controller 106 determines that the request is invalid, the controller 106 can provide an error message to the requesting client device 108. In some implementations, the controller 106 may identify specific issues with the request.

At step 210, the controller 106 can use the list of inference systems 102 (and their corresponding data) and the parsed inference task data to select one or more inference systems 102 to execute the requested inference task. The controller 106 can use any suitable selection process to select one or more inference systems 102 to execute the received inference task. In some implementations, the controller 106 can rank the available inference systems 102 in the list based at least on their processing capabilities and current workload (e.g., available processing resources, etc.). The ranking can be determined by evaluating factors such as the type of hardware (e.g., GPU model, CPU architecture), memory capacity, and available storage, as well as the processing requirements for the requested inference task. In some implementations, the controller 106 can rank the list of inference systems based at least on any attributes of the inference task, including but not limited to the volume, type, or formatting of the input data, the type of machine-learning operation to be performed, the selection of machine-learning model 104 to execute (if selected/provided in the request), and the requested output data type/format to be generated via execution of the inference task, among others. In some implementations, the controller 106 can prioritize inference systems 102 that are currently idle or have lower workloads to optimize resource utilization and minimize latency.

One or more inference systems 102 having the highest priority can be selected as candidate inference systems 102. To determine whether a selected candidate inference system 102 is available to execute the inference task, the controller 106 can communicate with the inference system 102 to check its current status. For example, the controller 106 can send a request to the API endpoint of the candidate inference system 102 to query its availability and responsiveness. The request can be associated with a timer corresponding to an expiration period. If the candidate inference system 102 responds with an indication that the candidate inference system 102 is available to execute the inference task within the specified timeout period, the controller 106 can select that inference system 102 to execute the inference task. If the candidate inference system 102 does not respond within the timeout period, or responds with an indication that the inference system 102 is unavailable or does not have available processing resources to execute the inference task, the controller 106 can mark it as unavailable and select another candidate inference system 102 having the next highest priority. In some implementations, the controller 106 may select multiple inference systems 102 to execute at least a portion of the inference task. In some implementations, multiple inference systems 102 may be selected when an inference task has a volume of data that exceeds a threshold and/or multiple suitable inference systems 102 are available and capable of executing the inference task.

In some implementations, the controller 106 can store and maintain a list (e.g., a schedule) of active or scheduled tasks to be executed or currently being executed by one or more inference systems 102. The list/schedule can include details such as the identifier of the inference system 102 assigned to each task, the status of the task (e.g., pending, in progress, completed), and any relevant timestamps or progress indicators. In some implementations, the controller 106 can update the schedule to indicate the selected inference systems 102. In some implementations, if the controller 106 is unable to select an inference system 102 for the inference task, the controller 106 may return an error message to the requesting client device 108.

At step 212, the controller 106 can provide an indication to the client device 108 that an inference system 102 has been assigned to the inference task. In some implementations, the controller 106 can coordinate execution of the inference task. In such implementations, the controller 106 can request, retrieve, and/or provide any input data corresponding to the inference task to the selected inference system(s) 102. In some implementations, the controller 106 may not necessarily coordinate execution of the inference task. In such implementations, the controller 106 can provide the network address(es) of the selected inference system(s) 102 to the requesting client device 108. The network addresses may be URLs or URIs corresponding to API endpoints of the selected inference devices. Upon receiving the network address(es), the application 112 of the client device 108 can transmit the input data for the inference task, and any related parameters for the inference task, to the selected inference systems 102 via the network address(es), in one or more requests to execute the inference task.

The selected inference system(s) 102 can automatically execute the requested inference task using received input data and its stored machine-learning models 104 and/or software components/services. The inference system 102 can receive or retrieve the input data from the controller 106 or from the requesting client device 108, as described herein. Once the input data is received, the inference system 102 can process the data using locally stored machine-learning models 104 and/or other software components/services, such as data pre-processing services. In one example, the inference system(s) 102 can execute a data pre-processing service to pre-process and format the input data to conform to the input format for the machine-learning model 104. The inference system 102 can provide the input data to the specified machine-learning model 104 to generate requested output data.

In some implementations, multiple selected inference systems 102 may communicate with one another to execute different portions of the inference task. For example, one inference system 102 can execute data pre-processing operations, while another inference system 102 can execute the machine-learning model 104. The inference systems 102 can communicate, for example, using one or more API calls or other communication protocols. The inference system(s) 102 can provide the output data to an output location as it is generated or when the task is completed. The output location can include the controller 106, a storage location specified in the request, or the requesting client device 108, or any other output location. In some implementations, the inference system(s) 102 may store the output data locally until requested by a computing device connected to the local network 110. The inference system(s) 102 can transmit the output data in real-time or in batches, in some implementations, configuration for which may be specified in the inference task data.

In some implementations, at step 214, the controller 106 can monitor the execution progress of one or more inference tasks. The controller 106 can monitor the execution of an inference task once initiated by communicating with the selected inference system(s) 102 to determine the status of the inference system(s) 102 and/or the progress of the inference task. For example, the controller 106 can periodically send status requests to the API endpoint of the inference system 102 to check the current state of the task. The status requests can include requests for the current progress, any errors encountered, and the estimated time to completion, among other attributes of the inference task. In response to the status request(s), the inference system 102 can provide one or more response messages including about the status of the inference task (e.g., percentage/degree of completion, a current processing stage, execution performance metrics or logs, etc.).

The controller 106 can update the list/data structure of active/scheduled tasks to reflect the new task. The controller 106 can add an entry to the list that includes the identifier of the inference system(s) 102, the task details, and the initial status (e.g., pending, in progress). As the inference system(s) 102 makes progress on the inference task as indicated by the progress messages from the inference system(s) 102, the controller 106 update the status of the inference task in the list/data structure. For example, the controller 106 can mark the task as “in progress” once execution begins or update the task as “completed” once the inference system(s) 102 indicate that execution of the inference task has completed.

In some implementations, an inference system 102 executing or scheduled to execute an inference task may report an error, system fault, or another indication that execution of the inference task cannot be completed. In some implementations, in response to receiving an indication that the inference task cannot be completed by the selected inference system(s) 102, the controller 106 can automatically perform the operations of step 210 to select different inference system(s) 102 to execute the inference task. In some implementations, the controller 106 can store an indication of the error condition or other information relating to the inference systems 102 that failed to execute the inference task.

At step 216, once the controller 106 determines that execution of the inference task has completed, the controller 106 can provide an indication that the inference task has been executed to the client device 108. In implementations where the controller 106 coordinates execution of the inference task, the controller 106 may automatically retrieve/receive the output data of the inference task from the inference system(s) 102 and provide the output data to the client device 108. In implementations where the application 112 coordinates execution of the inference task, the application 112 may automatically retrieve/receive the output data of the inference task from the inference system(s) 102 and provide an indication to the controller 106 that the inference task has completed. In some implementations, the inference task may designate a storage location (e.g., a network drive, storage of a computing system) on the local network 110 at which the store the results of the inference task, rather than or in addition to returning the output data to the requesting client device 108. The controller 106 can repeatedly perform any of the operations of the process 200, in any order or arrangement, to perform any of the operations described herein.

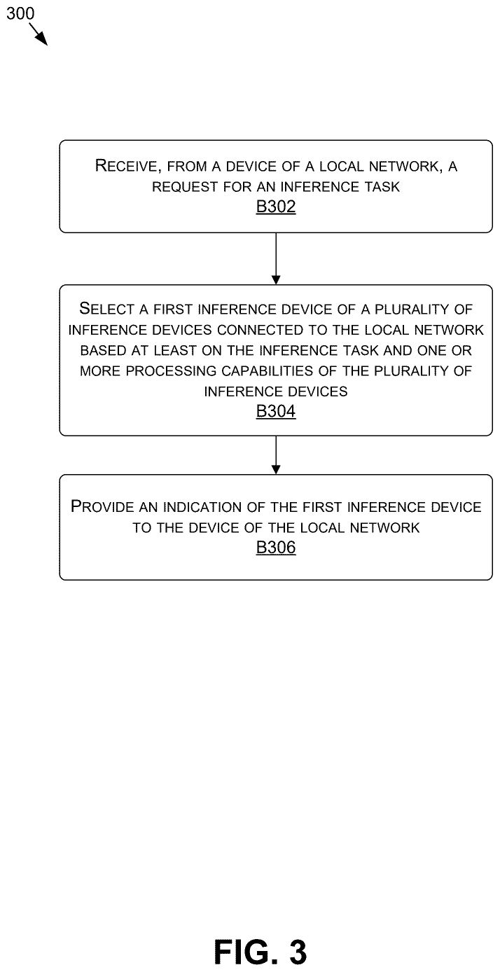

FIG. 3 is a flow diagram showing a method 300 for implementing inference operations on local networks. The method 300, at block B302, includes receiving, from a device (e.g., a client device 108) of a local network (e.g., the local network 110), a request for an inference task. The inference task may be a task to process data using one or more services and/or machine-learning models (e.g., machine-learning model(s) 104, etc.). The inference task may be transmitted by an application (e.g., an application 112) of the device, as described herein. In some implementations, the device may be or include an IoT device having one or more sensors. In some implementations, the inference task may be transmitted in response to use input at a user interface. The inference task can specify/identify input data, the operation(s) to be performed, requested output data, or any other attribute described herein.

The method 300, at block B304, includes selecting a first inference device of a plurality of inference devices (e.g., the inference systems 102A-102N) connected to the local network based at least on the inference task and one or more processing capabilities of the plurality of inference devices. To do so, any of the operations described in connection with the controller 106 may be performed. For example, the inference devices of the local network may be ranked/prioritized based on their processing capabilities (e.g., available hardware, software, idle computational resources, etc.) and the processing requirements (e.g., corresponding machine-learning operations, volume/format of data, etc.) of the inference task. In some implementations, one or more inference devices may be queried/requested to provide status information. Inferences devices that do not provide status information (e.g., a health signal) within a predetermined time (e.g., an expiration period) may be omitted from selection. The first inference device can be selected as the highest-ranked inference device that is available to perform the inference task, in some implementations.

The method 300, at block B306, includes providing an indication of the first inference device to the device of the local network. As described herein, in some implementations, a network identifier of the selected inference device can be provided to the device requesting execution of the inference task. The requesting device can use the network address as an endpoint to send the input data and/or parameters of the inference task for execution. In some implementations, the computing device performing the method 300 (e.g., the controller 106, etc.) can coordinate execution of the inference task by communicating the input data and/or parameters of the inference task to the first inference device. The first inference device can receive the input data and can execute the operations of the inference task to generate output data. The output data can be provided to the requesting device, stored in a designated storage location, or stored locally at the first inference device for execution.

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models such as one or more large language models (LLMs), one or more small language models (SLMs), one or more vision language models (VLMs), one or more multi-modal language models (MMLMs), systems for performing light transport simulation, systems for performing collaborative content creation for 3D assets, systems implemented at least partially using cloud computing resources, and/or other types of systems.

### EXAMPLE COMPUTING DEVICE

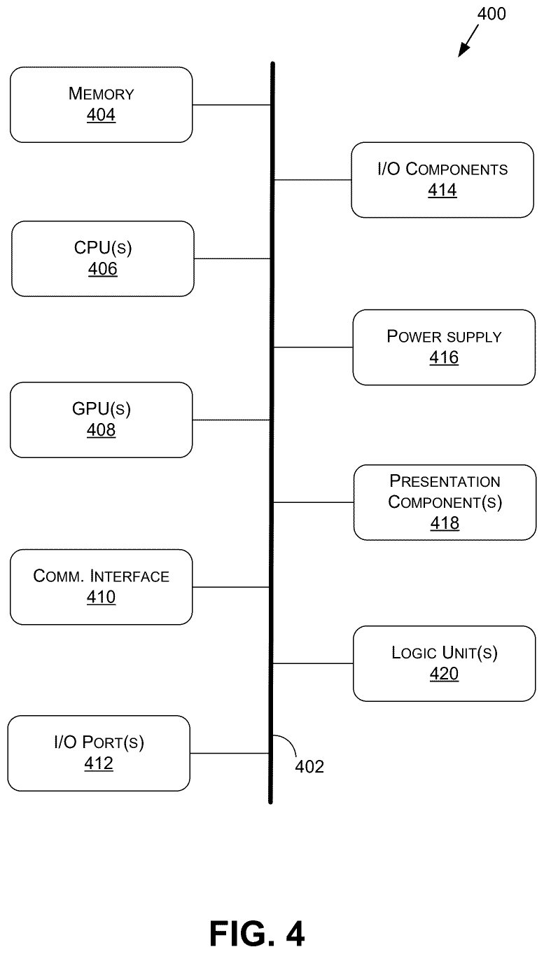

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or buses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### EXAMPLE DATA CENTER

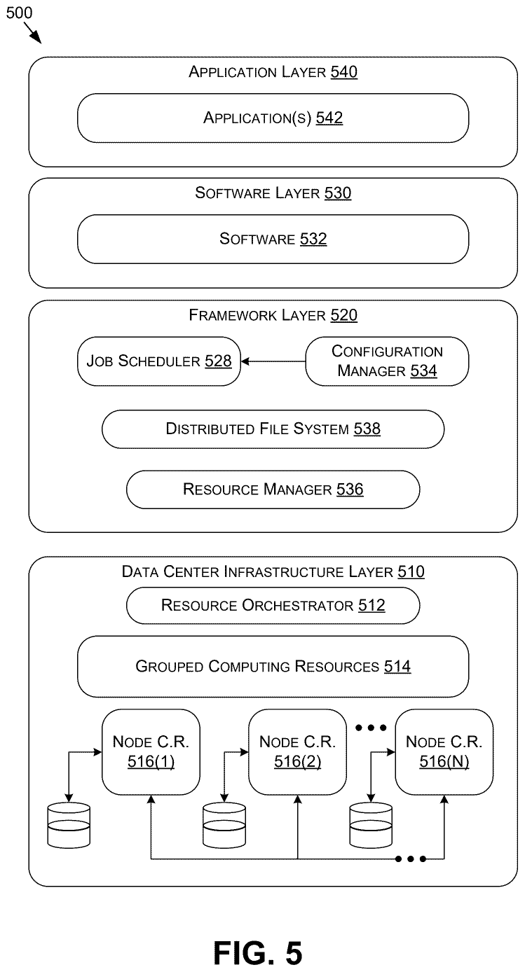

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4-e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive, from a device of a local network, a request for an inference task;
select a first inference device of a plurality of inference devices connected to the local network based at least on the inference task and one or more processing capabilities of the plurality of inference devices; and
provide an indication of the first inference device to the device of the local network in response to the request.

2. The one or more processors of claim 1, wherein the one or more circuits are to:
store a list of identifiers of the plurality of inference devices in association with the one or more processing capabilities; and
select the first inference device according to an order of the list of identifiers.

3. The one or more processors of claim 2, wherein the one or more circuits are to:
update the list of identifiers of the plurality of inference devices based at least on one or more responses to a multicast message transmitted via the local network.

4. The one or more processors of claim 1, wherein the one or more circuits are to:
provide a network address of the first inference device as part of the indication.

5. The one or more processors of claim 1, wherein the one or more circuits are to:
receive, from the first inference device, data indicative of at least one machine-learning model stored at the first inference device; and
update the one or more processing capabilities of the plurality of inference devices based at least on the data indicative of the at least one machine-learning model.

6. The one or more processors of claim 1, wherein the one or more circuits are to:
determine that the first inference device comprises sufficient computational resources for the inference task; and
select the first inference device responsive to determining that the first inference device comprises sufficient computational resources for the inference task.

7. The one or more processors of claim 1, wherein the one or more circuits are to:
transmit, to a second inference device of the plurality of inference devices, a message corresponding to the inference task;
determine that the second inference device failed to provide a response to the message within a time limit; and
select the first inference device responsive to determining that the second inference device failed to provide the response within the time limit.

8. The one or more processors of claim 1, wherein the one or more circuits are to:
receive data for the inference task from the device of the local network;
provide the data for the inference task to the first inference device responsive to selecting the first inference device; and
receive, from the first inference device, output information generated by the first inference device according to the inference task.

9. The one or more processors of claim 1, wherein the one or more circuits are to:
generate a schedule for a plurality of inference tasks received from a plurality of devices via the local network.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a vision language model (VLM);
a system for performing generative AI operations using a multimodal language model (MMLM);
a system for generating synthetic data;
a system incorporating one or more virtual machines (VMs);
a system implemented at least partially in a data center; or
a system implemented at least partially using cloud computing resources.

11. A system, comprising
a plurality of inference devices in communication via a local network, each of the plurality of inference devices storing a respective machine-learning model;
a controller device in communication with the local network, the controller device to:
generate, via communications with the local network, a list of the plurality of inference devices in communication with the local network;
receive an indication of an inference task from a client device;
select an inference device of the plurality of inference devices based at least on the inference task the respective machine-learning model stored at each of the plurality of inference devices; and
generate a response to the request based at least on the selected inference device.

12. The system of claim 11, wherein the controller device is to:
provide a local network address of the selected inference device in response to the request.

13. The system of claim 11, wherein the controller device is to:
communicate data for the inference task to the selected inference device;
monitor execution of the inference task at the selected inference device; and
provide, to the client device, an output of the inference task generated by the selected inference device.

14. The system of claim 11, wherein the controller device is included in the plurality of inference devices.

15. The system of claim 11, wherein the selected inference device is a first inference device, and wherein the controller device is to:
determine, based at least on second network communications, that a second inference device of the plurality of inference devices is unavailable to perform the inference task; and
select the first inference device based at least on the second inference device being unavailable.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a vision language model (VLM);
a system for performing generative AI operations using a multimodal language model (MMLM);
a system for generating synthetic data;
a system incorporating one or more virtual machines (VMs);
a system implemented at least partially in a data center; or
a system implemented at least partially using cloud computing resources.

17. A method, comprising:
receiving, using one or more processors, from a device of a local network, a request for an inference operation;
selecting, using the one or more processors, a first inference device of a plurality of inference devices connected to the local network based on at least one of the inference operation or one or more processing capabilities of the plurality of inference devices; and
allocating, using the one or more processors, at least a portion of the inference operation to the first inference device.

18. The method of claim 17, further comprising:
storing, using the one or more processors, a list of identifiers of the plurality of inference devices in association with the one or more processing capabilities; and
selecting, using the one or more processors, the first inference device according to an order of the list of identifiers.

19. The method of claim 18, further comprising:
updating, using the one or more processors, the list of identifiers of the plurality of inference devices based at least on one or more responses to a multicast message transmitted via the local network.

20. The method of claim 17, further comprising:
providing, using the one or more processors, an indication of the first inference device to the device of the local network in response to the request, the indication including a network address of the first inference device.
